(19) United States
(12) Patent Application Publication
(10) Pub. No.: US 2009/0003961 A1
(43) Pub. Date: Jan. 1, 2009

(54) DEVICE FOR MOUNTING COMPONENTS ON ONE ANOTHER WITH THE AID OF A CLAMP THAT SLIDES ON ONE COMPONENT

(75) Inventors: Matthias Benkel, Fuerstenfeldbruck (DE); Otto Demel, Heidelberg (DE); Stefan Schaaf, Geinsheim (DE); Markus Senftleber, Ketsch (DE); Quyet Pham, Muenchen (DE)

Correspondence Address: LEYDIG VOIT & MAYER, LTD, 700 THIRTEENTH ST. NW, SUITE 300, WASHINGTON, DC, 20005-3960, US

(73) Assignee: LISI AUTOMOTIVE RAPID, Puiseux Pontoise (FR)

(21) Appl. No.: 12/109,406

(22) Filed: Apr. 25, 2008

(30) Foreign Application Priority Data
Apr. 27, 2007 (DE) 20 2007 006 097.1

(51) Int. Cl. F16B 39/00; F16B 33/00

(52) U.S. Cl. 411/190; 411/366.1

(57) ABSTRACT

A device for mounting components, such as metal sheets, on one another, includes a clamp with external elastic U-shaped tongues that slide over an edge of a first component, and a section that is located between the tongues and includes an internal thread, and a screw that can engage the internal thread for mounting a second component on the first component. The screw has a thread pitch suitable for plastic materials and a correspondingly small flank angle. The internal thread has a region that is tapped, is located in, and helically extends from the central clamp section. The internal thread has more than one flight and one thread pitch for engaging the thread pitch of the screw thread.

### FIELD OF THE INVENTION

The invention pertains to a device for mounting components such as metal sheets on one another, wherein the device features a clamp that is made of a section of strip-shaped material, e.g., sheet metal, and consists of external elastic U-shaped tongues that are used to slide over the edge region of one component, a section that is located between the tongues and provided with a thread, and a screw that can be screwed into this thread and serves for mounting the second component on the first component.

### BACKGROUND

Known devices of this type have the disadvantage that they are only suitable for screws that are typically used for sheet metal threads and metric threads. In mounting clamps of the aforementioned type, however, it would also be desirable to utilize self-tapping screws that are intended for plastic materials.

### SUMMARY OF THE INVENTION

The present invention therefore is based on the objective of developing a mounting device of the aforementioned type, in which the clamp consists of sheet metal, but is also suitable for use with screws intended for plastic materials.

In order to realize this objective, the inventive device includes a screw having a high thread pitch suitable for plastic materials and a small flank angle, and the thread has a region that is tapped into the central clamp section and helically extracted therefrom, wherein the thread has more than one flight and a thread pitch that is adapted to the thread pitch of the screw thread.

Other advantageous characteristics of the invention form the objects of the dependent claims.

### BRIEF DESCRIPTION OF DRAWING FIGURES

The inventive device is described in greater detail below with reference to the enclosed drawings.

FIG. 1 shows a perspective representation of an inventive mounting device.

FIG. 2 shows a side view of FIG. 1.

FIG. 3 shows a perspective representation of a first embodiment of an inventive mounting clamp.

FIG. 4 shows a perspective representation of another embodiment of an inventive mounting clamp.

FIG. 5 shows a different view of the mounting clamp according to FIG. 4 and a corresponding mounting screw.

FIG. 6 shows a perspective representation of a different variation of the clamp shown in FIG. 4.

### DETAILED DESCRIPTION

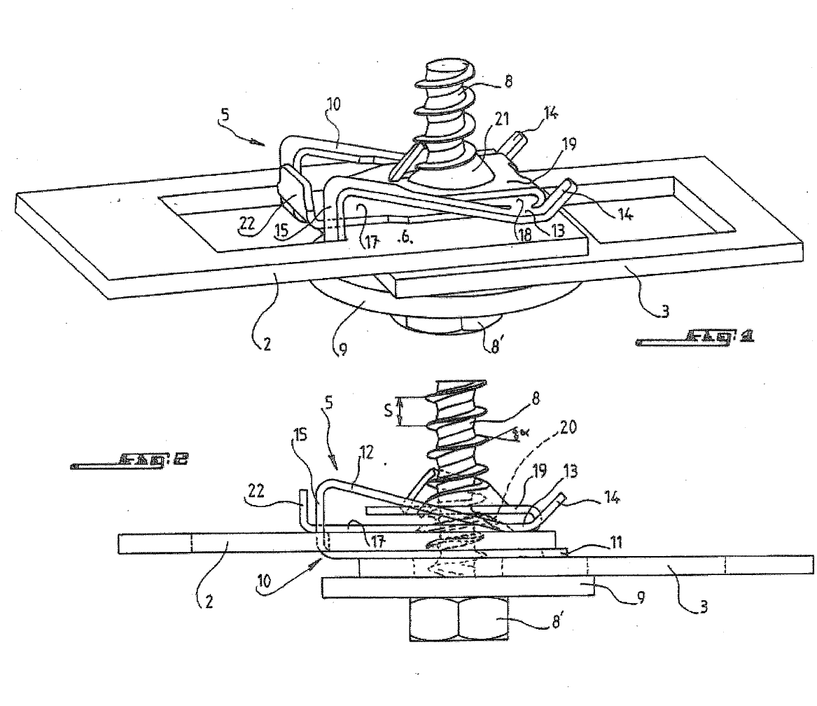

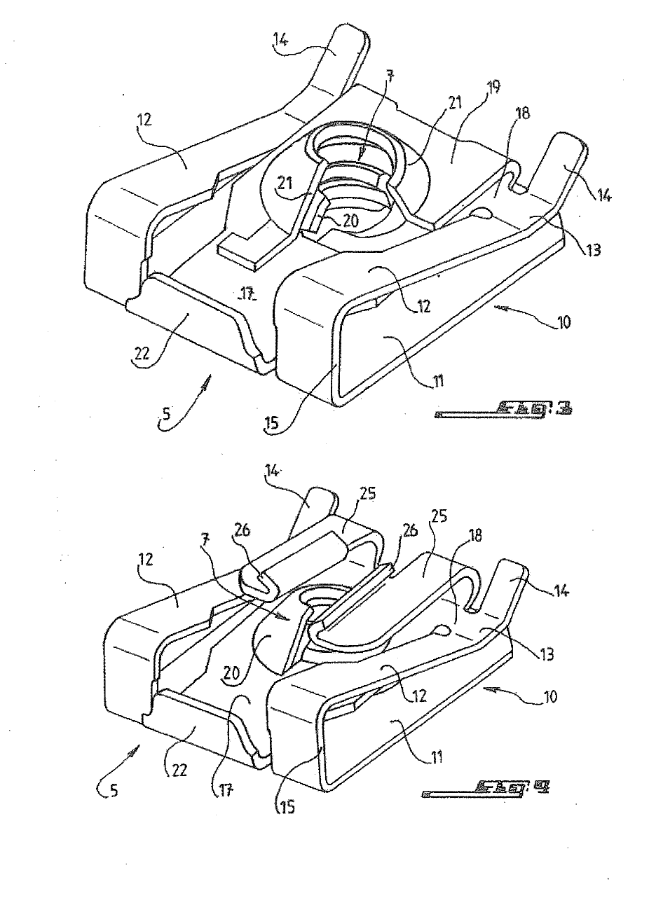

FIG. 1 shows an inventive mounting device in its operating position for mounting two flat components 2, 3 on one another. The mounting device 1 consists of a clamp 5 that is slid over an edge region 6 of the component 2 and features a thread 7, as well as a screw 8 that is screwed into this thread and holds the second component 3 on the first component 2, by means of a washer 9 arranged between the head 8′ of the screw and the component 3.

The clamp 5 is made of a section of strip-shaped material, particularly sheet metal. The different regions of the clamp are produced by partially cutting out and then bending the strip-shaped material section to the appropriate shape. On each of its outer edges that are oriented in the direction of the longitudinal axis of the clamp, the clamp 5 features a clamping tongue 10 that is cut out and bent in the form of a U, wherein the lower leg 11 of said clamping tongue lies between the two components 2 and 3 in its mounting position, and wherein the upper elastic leg 12 of the clamping tongue lies on the component 2 with its free upper end section 13 and exerts thereon a certain compressive force. The free end 14 of the tongues is bent upward. The base 15 of the U-shaped clamping tongues 10 is wider than the front pressing region 13. The central section 17 of the clamp lies flatly on the surface of the clamped component 2 and is connected to the region 13 that lies and exerts pressure on the component 2 by means of a remaining ridge-like region 18 of the original strip-shaped material section. The central section 17 is extended forward by means of a section 19 that is bent back toward the section 17, and with it forms a U. The thread 7 that features two flights 20, 21 in FIGS. 1 and 2 is realized in the central region of the bent-back section 19, wherein one flight 20 is arranged in the clamp section 17 and the other flight is arranged in the section 19 that is bent back above said clamp section. These flights are produced by tapping and helically drawing out the thread perpendicularly outward, as is clearly illustrated in the figures. For reasons of completeness, it should also be noted that the free rear end 22 of the flat central section 17 of the clamp is bent upward.

The double threads 20, 21 that are helically drawn out from the plane of the central clamp sections 17 and 19 have a relatively high thread pitch that corresponds to the thread pitch of the screw 8, wherein said screw is suitable for self-tapping a thread into plastic components and has a high pitch S, e.g., of 2.24 mm and a small flank angle α, e.g., of 30°.

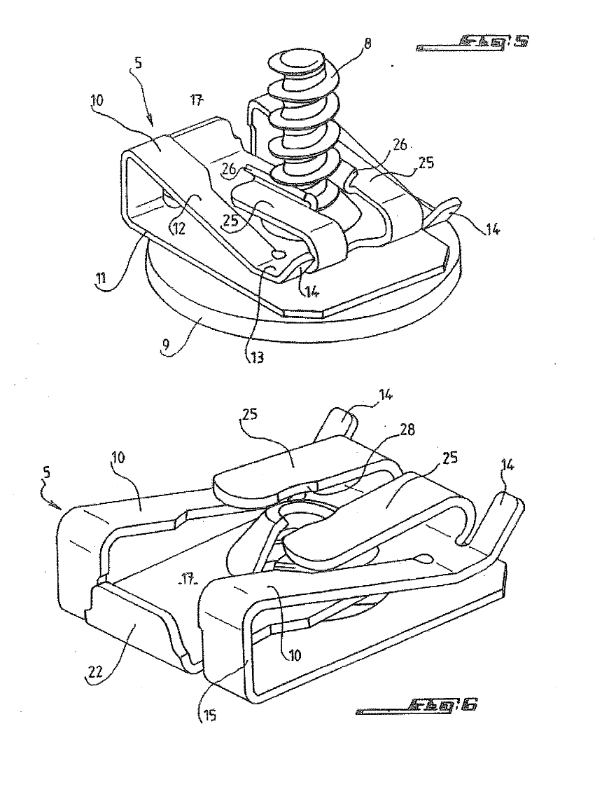

FIGS. 4 and 5 show a second embodiment, in which only one thread with one flight is realized in the central section 17 of the clamp that lies flatly on the component 2 by means of a helical extraction, wherein the section that is bent back and designated by the reference symbol 19 in FIGS. 1 and 2 is realized in the form of two parallel lateral tongues 25. The inner edges 26 of these tongues that are oriented in the longitudinal direction are bent upward into the zone of the screw and engage into the screw thread lying between these edges as shown. Consequently, the tongues that thereby engage into the thread act as an additional thread pitch section and prevent the unintentional loosening of the screw in the axial as well as the radial direction, e.g., due to material settling or vibrations, because they are elastically pressed against the flanks of the screw thread.

In the embodiment shown in FIG. 6, the lateral inner edges engaging into the screw thread are provided with a cutout 28 that has the shape of a circular arc and is adapted to the screw diameter.

1. A device for mounting components on one another, comprising:
a clamp made from a strip material, the clamp including
outer elastic U-shaped tongues slidable over an edge of a first component and,
a central section located between the tongues and including an internal thread and
a screw for engaging the internal thread and mounting a second component on the first component, wherein
the screw has a thread pitch suitable for engaging plastic materials and a small flank angle, and
the internal thread includes a helical, wound portion cut from the central section, and drawn from the central section, in a direction perpendicular to the central section, and having a thread pitch for engaging the thread pitch of the screw thread.

2. The device according to claim 1, wherein the central section of the clamp, located between the two tongues, is bent and has a U-shape in a side view and includes first and second legs that include parts of the internal thread.

3. The device according to claim 2, wherein the leg of the clamp that is slidable over the first component and has a first flight produced by tapping and helically drawing the internal thread from the first leg, and the second leg includes a second flight.

4. The device according to claim 3, wherein the second flight is produced by tapping and helically drawing the internal thread.

5. The device according to claim 3, wherein the second leg includes two parallel tongues having inner edges for engaging the thread of the screw.

6. The device according to claim 5, wherein the inner edges of the tongues that engage the screw thread include frictional safety elements for preventing the screw from loosening due to vibrations.

7. The device according to claim 6, wherein the inner edges of the tongues are bent and elastically contact flanks of the screw thread.
